(19) United States
(12) Patent Application Publication
(10) Pub. No.: US 2015/0122994 A1
(43) Pub. Date: May 7, 2015

(54) PASSIVE MILLIMETER WAVE IMAGE CONVERTER

(71) Applicants: Mikio Larry YUJIRI, Manhattan Beach, CA (US); Richard LAI, Redondo Beach, CA (US); Lakshminarayanan R. NARASIMHAN, Redondo Beach, CA (US)

(72) Inventors: Mikio Larry YUJIRI, Manhattan Beach, CA (US); Richard LAI, Redondo Beach, CA (US); Lakshminarayanan R. NARASIMHAN, Redondo Beach, CA (US)

(73) Assignee: NORTHROP GRUMMAN SYSTEMS CORPORATION, Falls Church, VA (US)

(21) Appl. No.: 14/072,464

(22) Filed: Nov. 5, 2013

(51) Int. Cl. G01S 13/89

(52) U.S. Cl. CPC G01S 13/89
USPC 250/336.1

(57) ABSTRACT

An imaging system is provided. The system includes a receiver to passively receive a millimeter wave (MMW) power level input from a scene and generates an analog output signal. A driver circuit receives the analog output signal and generates a drive output signal based on the amplitude of the analog output signal. A wavelength converter generates a light intensity output is a replica of a portion of the scene associated with the MMW power level input at a different wavelength range than the MMW power level input wavelength range.

### TECHNICAL FIELD

This disclosure relates to passive imaging systems, and more particularly to systems that perform wavelength conversion of passively collected millimeter wave input power levels to signal output intensities for imaging.

### BACKGROUND

Millimeter Wave (MMW) is the radiation band with wavelengths from one millimeter to 10 millimeters. As radio waves are considered low band frequency, millimeter waves are designated as very high frequency. Regardless of the frequency of the radiation, just like light, millimeter waves can be found throughout the environment. For example, the human body is a natural emitter of such radiation and thus, imagers can be designed to passively (without emitting power) capture radiation emitted from the body including use in non-invasive scanning technologies (e.g., explosive device detection on humans). There are several advantages to passively image millimeter wave radiation from scenes. First, imaging through atmospheric obscurants like fog, smoke, dust, and even clothing is possible. Second, the person is not exposed to any radiation that is not already all around them so there is no concern that the imaging device is harmful, such as from x-ray machines, for example. Further, the length of the millimeter wave is large, so the inherent imaging resolution is low, reducing the impact on personal privacy (e.g., images are not so revealing). Third, there are fewer man-made sources in this domain to clutter the scene. Finally, imaging can be performed covertly as there are no emissions from a passive imager.

In earlier passive millimeter wave (PMMW) imager configurations, a lens is employed to passively collect the millimeter wave radiation from the scene and focus it onto a two-dimensional focal plane array (FPA) of monolithic microwave integrated circuit (MMIC)-based receivers. These receivers (e.g., radiometers) convert the radiation into a usable electrical signal. These signals are then electronically processed (amplified, digitized, multiplexed), and sent as a digital stream to a bank of processors where an image is constructed and displayed. The process of image conversion can be expensive both in economic complexity of integrated circuits to perform the conversion and in terms of processing expense to produce the image from the captured waveforms.

### SUMMARY

This disclosure relates to systems and methods for performing passive millimeter wave (PMMW) imaging. In one example, an imaging system is provided. The system includes a receiver to receive a millimeter wave (MMW) power level input from a portion of the scene and generates an analog output signal. A driver circuit receives the analog output signal and generates a drive output signal based on the amplitude of the analog output signal. A wavelength converter generates a light intensity output in response to the drive output signal, wherein the light intensity output is a replica of a portion of the scene associated with the MMW power level input at a different wavelength range than the MMW power level input wavelength range.

In another example, an imaging system includes an optical front end for passively capturing a millimeter wave image of a scene. The system includes an imaging assembly that also includes a plurality of focal plane array receivers that each receives a MMW power level input associated with the MMW image and each generates a respective analog output signal. The assembly includes a plurality of driver circuits that each receives a respective analog output signal and generates a respective drive output signal based on the amplitude of the corresponding analog output signal. The assembly also includes a plurality of wavelength converters that each generates a light intensity output in response to a respective drive output signal. The light intensity output is a replica of a portion of the scene associated with the MMW power level input at a different wavelength range than the MMW power level input wavelength range.

In yet another example, an imaging system includes an optical front end for passively capturing a millimeter wave (MMW) image of a scene. The system includes a focal plane array (FPA) consisting of a plurality of feed antennas that each samples a portion of the MMW image of the scene coming from the optical front end, and generates an antenna output signal. The FPA includes a plurality of low noise amplifiers that boost the antenna output signal to generate a MMW power level input associated with the MMW image. The FPA includes a plurality of detectors that each receives the MMW power level input associated with the MMW image and each generates a respective analog output signal. The FPA includes a plurality of driver circuits that each receives a respective analog output signal and generates a respective drive output signal based on the amplitude of the corresponding analog output signal. The FPA includes a plurality of light emitting diodes (LEDs) that each generates a light intensity output in response to a respective drive output signal. The light intensity output is a replica of a portion of the scene associated with the MMW power level input from one of the feed antennas, at a different wavelength range than the MMW power level input wavelength range. The imaging system also includes an image capture device that captures an image of the scene formed by the light intensity outputs of the LEDs.

### BRIEF DESCRIPTION OF THE DRAWINGS

FIG. 1 illustrates an example of a passive millimeter wave image conversion system.

FIG. 2 illustrates an example of a passive millimeter wave wavelength converter circuit.

FIG. 3 illustrates an example of a passive millimeter wave image conversion and image capture system.

FIG. 4 illustrates an example portion of a focal plane array having a single row of conversion components.

FIG. 5 illustrates an example of a passive millimeter wave image conversion circuit having a coplanar configuration.

FIG. 6 illustrates an example of a passive millimeter wave image conversion circuit having alternative row and column arrangements in a focal plane array.

FIG. 7 illustrates an example of a passive millimeter wave image conversion circuit configured as a focal plane array.

### DETAILED DESCRIPTION

This disclosure relates to passive millimeter wave imaging systems. Millimeter wave (MMW) radiation is passively captured from a scene in the form of an input power level associated with the radiation. For example, MMW radiation at 94 GHz can be received at a measureable power level from the human body. The imaging system can include a lens to focus a portion of the passively collected MMW radiation onto a feed antenna which collects the MMW power (e.g., collected from a body or other radiating object at a checkpoint). A low noise amplifier amplifies the received MMW power level input from the feed antenna to increase the available signal level in view of background noise. A detector (e.g., diode detector) receives the amplified MMW power level input from the low noise amplifier and generates an electrical signal output where a driver circuit generates a drive output signal in response to the electrical signal output from the detector. A wavelength converter such as a light emitting diode (LED), for example, receives the drive output signal from the driver circuit and generates a light intensity output that is proportional to the MMW power level input from the scene.

Although visible light imagers are typically employed, other non-visible wavelength conversions such as infrared light or ultraviolet light are also possible. After converting the input power level from the scene to a given wavelength via the wavelength converter, an image capture device (e.g., video camera, pixilated integrated circuit sensor) can be employed to generate an image of the scene from the signal intensity output of the wavelength converter. In some examples, the images can be viewed directly with the eye at the output of the wavelength converter (e.g., goggle-like or binocular-like optical imagers). In another example, a camera or other capture device can capture the respective images at the output of the wavelength converter. In yet another example, fiber optic couplings can be employed to couple the output from the wavelength converter to the image capture device which may be at a remote location. By converting captured MMW power levels directly to visible wavelengths, (or other non-visible wavelengths), complex phase and image reconstruction processing hardware can be eliminated while simplifying overall system design. In some examples, the systems can be conveniently fabricated on an integrated circuit such as a focal plane array (FPA).

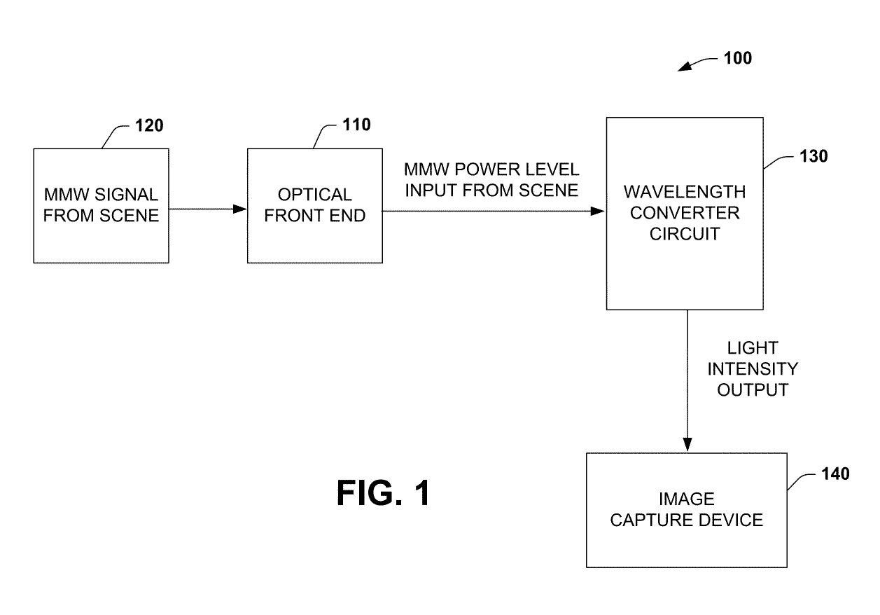

FIG. 1 illustrates an example of a passive millimeter wave (PMMW) image conversion system 100. The image conversion system 100 includes an optical front end 110 to receive MMW radiation from a scene at 120. The optical front end 110 can include a lens to focus the MMW radiation from the scene, for example. Output from the optical front end 110 is passed to a wavelength converter circuit 130 which converts the incoming MMW power level input of the scene received from the optical front end 110 to a light intensity output which is proportional to the MMW power level input. The light intensity output is a replica of the MMW power level associated with the scene input but at a different wavelength.

By converting the MMW power level input to an analog signal, no phase information is produced at the output of the wavelength converter circuit 130 which greatly simplifies operation and expense of the image conversion system 100. For example, images can be directly viewed at the output of the wavelength converter circuit 130 as a pixilated array displaying the scene (e.g., viewing the backside of a FPA). Such viewing is a result of the direct image reconstruction of the scene at the output of the wavelength converter circuit 130 without the need for complex digital image reconstruction processing and phase-management hardware as in conventional PMMW imaging systems. The light intensity output from the wavelength converter circuit 130 can also be captured as an image via an image capture device 140 which could include the human eye, digital cameras, film cameras, pixilated sensors, and so forth. In another example, the light intensity output from the wavelength converter 130 could also be transported to remote locations via fiber optic cabling (e.g., each cable coupling one pixel's worth of information from a pixilated array output of the wavelength converter) where the image capture device 140 could be located remotely and the image captured by filming or recording the light intensity coming out of the ends of the fiber cables.

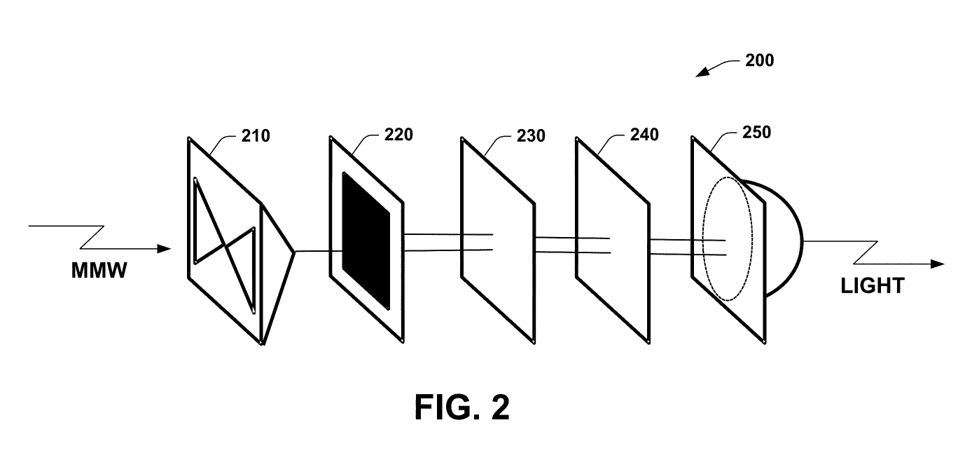

As will be illustrated and described below with respect to FIG. 2, the wavelength converter circuit 130 can include a receiver to receive the millimeter wave (MMW) power level input from the scene and generate an electrical signal output. A driver circuit in the wavelength converter 130 receives the electrical signal output from the detector and generates a drive output signal in response to the MMW power level input from the scene. A wavelength converter within the wavelength converter circuit 130 receives the drive output signal from the driver circuit to generate the light intensity output that is proportional to the MMW power level input from the scene. As shown, the light intensity output can be employed to generate a replica of the scene that can be captured by the image capture device 140.

The wavelength converter circuit 130 can also include a low noise amplifier (LNA) to boost the received MMW power level input from the scene above background noise levels. A feed antenna within the wavelength converter circuit 130 collects the MMW power level input from the scene and provides the MMW power level input from the scene to the low noise amplifier which is then received by the detector. As will be illustrated and described below, the feed antenna, the low noise amplifier, the detector, the driver circuit, and the wavelength converter in the wavelength converter circuit 130 can be configured as a single integrated circuit pixel to provide one pixel's worth of information from the scene. By configuring a plurality of integrated circuit pixels, the wavelength converter circuit 130 can be configured as a focal plane array (FPA) assembly, for example. In one example, the wavelength converter inside the wavelength converter circuit 130 can be a light emitting diode (LED). Other wavelengths than from the visible spectrum can also be supported. For example, the LED can be configured to emit infrared spectrum frequencies, visible spectrum frequencies, or ultra violet spectrum frequencies. When non-visible conversions are performed by the wavelength converter circuit 130, the image capture device 140 can be configured accordingly. For example, an infrared sensor would be utilized in the image capture device 140 for infrared conversions or an ultraviolet sensor for ultraviolet conversions from MMW wavelengths.

FIG. 2 illustrates schematically an example of a millimeter wave (MMW) wavelength converter circuit 200. The circuit 200 can be configured as an integrated circuit, wherein a plurality of such circuits can be manufactured as part of an integrated circuit array, for example. The circuit 200 includes a feed antenna 210 to passively collect a millimeter wave (MMW) power level input from a scene. A low noise amplifier (LNA) 220 amplifies the received MMW power level input from the scene via the antenna 210. A detector 230 (e.g., diode detector) receives the amplified MMW power level input from the LNA 220 and generates an electrical signal output. A driver circuit 240 receives the electrical signal output from the detector 230 and generates a drive output signal in response to the electrical signal output from the detector. A wavelength converter (e.g., LED) receives the drive output signal from the driver circuit 240 to generate a light signal intensity output that is proportional to the MMW power level input from the scene. The signal intensity output is at a different wavelength than the MMW input from the scene and can be employed to generate an image of the scene that can be viewed directly or captured via an image capture device described above. In one example, the wavelength converter can be an LED configured for visible wavelengths. In other examples, the LED can be configured for non-visible wavelengths.

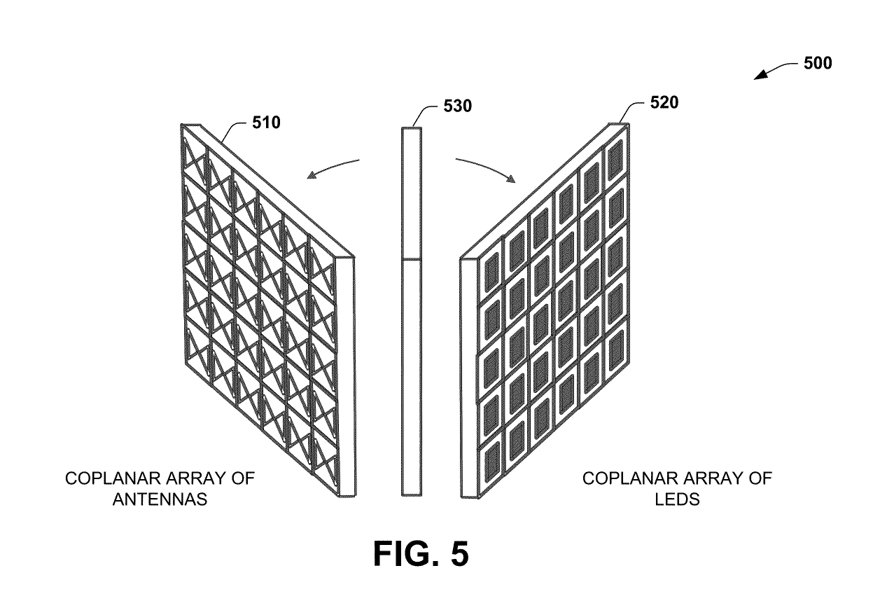

In conventional passive millimeter wave camera configurations, a lens passively collects the millimeter wave radiation from the scene and focuses it onto a two-dimensional focal plane array (FPA) of MMIC-based receivers. These receivers, also referred to as radiometers, convert the radiation into a usable electrical signal. These signals are amplified, demodulated, digitized, multiplexed, and sent as a digital stream to a bank of processors where an image is constructed and displayed. Such processing, depending on the front end optics, can include both complex amplitude and phase processing of the received MMW signals. The wavelength converter circuit 200 can simplify the image reconstruction process from the output of the MMIC receivers. Instead of the complex image reconstruction electronics described above, each receiver in an FPA configuration can drive a LED such that the backside of the FPA ends up having an array of LEDs (see FIGS. 5-7 below). The circuitry driving each LED can be independent of the others, and thus basically converts the signal level from the receiver (where level is proportional to the MMW power entering the FPA receiver) into a light level whose intensity is proportional to the MMW signal power level.

An image visible to the eye can be created by the wavelength converter circuit 200 (if the LEDs are emitting visible light) that corresponds to the MMW image collected by the FPA. In one example, an off-the-shelf video camera can be directed at the LED array to create a digital video stream that can be sent to a computer where image processing can be performed in real-time with software, and can easily be displayed. Thus, all the complex electronics of conventional PMMW imaging systems can be reduced to a straightforward analog LED driver and an off-the-shelf video camera (or other image capture device). In one example variation from using an image capture device, the output of each LED can be fed through separate fiber optic cables, and these fibers can be bundled and the light sent remotely to a video camera CCD array. The fibers should be arranged in a suitable order to correspond to their relative location at the back end of the FPA where the wavelength converters 250 would be mounted. This method would be useful if a video camera cannot be located near the FPA, where, for example, the size or volume of the camera is a consideration, and/or where electrical isolation is desired.

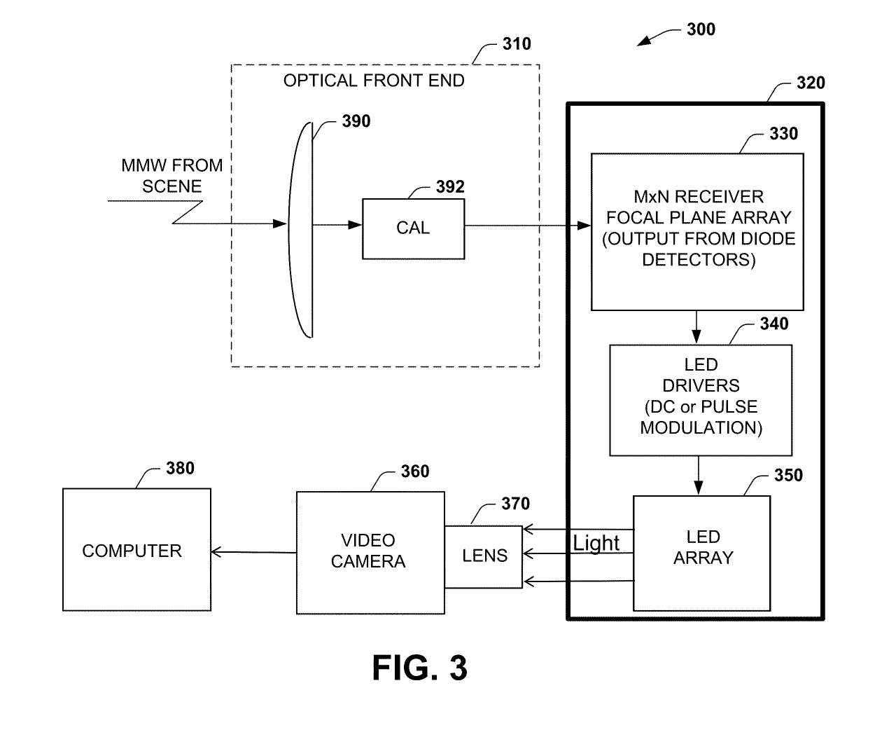

FIG. 3 illustrates an example of a passive millimeter wave (PMMW) image conversion and image capture system 300. The system 300 includes an optical front end 310 that passively collects and passes MMW radiation from a scene to a wavelength converter circuit 320. The wavelength converter circuit 320 includes an M×N focal plane array of feed antennas, low noise amplifiers, and diode detectors configured at block 330, wherein M and N are positive integers. Output from block 330 feeds an array of LED drivers 340 which drives an LED array 350. The LED drivers 340 can be DC current drivers or pulse width modulated drivers, for example. Output from the LED array 350 can be captured via a video camera 360 (or other capture device) having a lens 370. Note that this lens 370 can be eliminated if the LED array 350 can be placed up against the FPA within the video camera 360, thereby reducing the overall size of the system. Output from the video camera 360 can be stored at a computer 380 for further image processing, if desired. As shown, the optical front end 310 can include a lens 390 which passively collects radiation received from the scene and focuses it onto the wavelength converter circuit 320, and a calibration component 392 to provide calibration signals for the converter circuit.

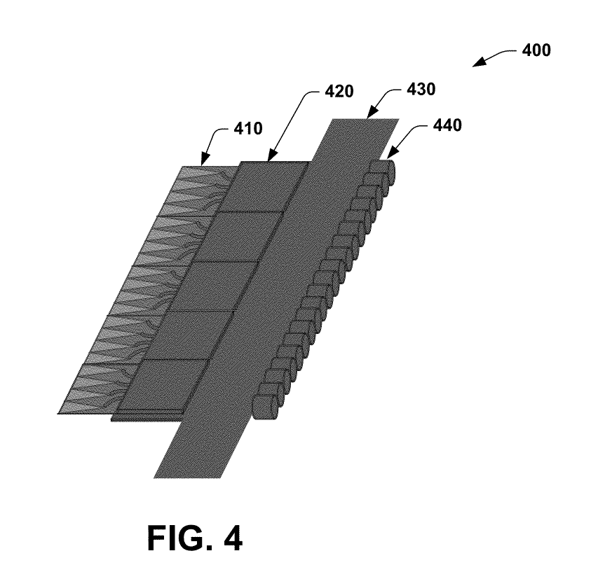

FIG. 4 illustrates an example portion of a focal plane array 400 having a single row of conversion components (this would be one row of the M×N FPA in 320). A row of feed antennas 410 passively collects MMW signals from the optical front end (not shown) and feeds it to a row of receiver modules 420. Each of these modules contains the low noise amplifiers and diode detectors constituting the MMW receivers. The row of receiver modules passes its output signals to a driver row 430 that drives an LED row 440. The row of LEDS 440 performs wavelength conversion as previously described. As will be illustrated and described below, the single row depicted at 400 can be stacked with other similar rows to provide a two-dimensional focal plane integrated circuit assembly configuration.

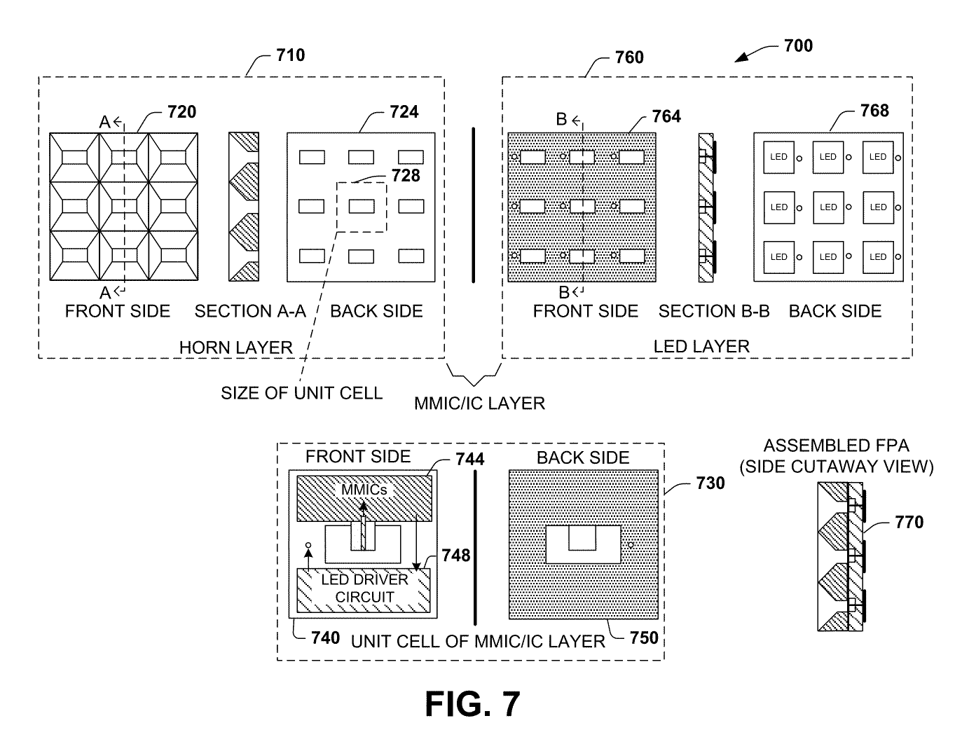

FIG. 5 illustrates an example of a passive millimeter wave image conversion circuit 500 having a coplanar configuration. In this example, a coplanar array of antennas at 510 can be coupled to a coplanar array of LEDS at 520 via an intermediate circuit layer 530. The intermediate circuit layer 530 can include the low noise amplifier layer, diode detection layer, and LED driver layer as previously described and will be illustrated with respect to FIG. 7. Although, a finite number of rows and columns are shown for the example circuit 500, the circuit can be configured as an M×N array having M rows and N columns, where M and N are positive integers.

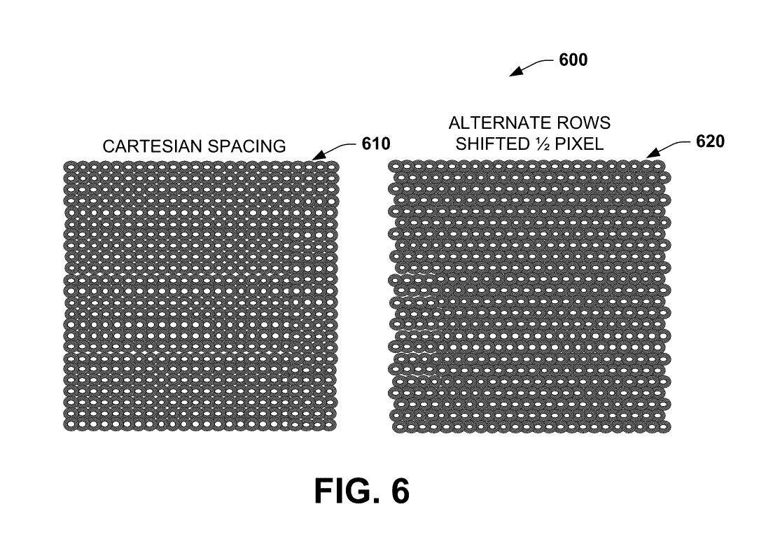

FIG. 6 illustrates an example of a passive millimeter wave image conversion circuit 600 having alternative row and column arrangements in a focal plane array. At 610, one possible arrangement of the coplanar LED elements depicted in FIG. 5 is shown. The arrangement at 610 shows a Cartesian spacing of elements where rows and columns are substantially aligned. At 620, an alternate configuration is shown where alternating rows can be shifted by a ½ pixel in this example. Such shifting can allow more efficient packing of pixels, for example. Other configurations are also possible (e.g., other fractional shifts in rows and/or columns).

FIG. 7 illustrates an example of a passive millimeter wave image conversion circuit 700 configured as a focal plane array. The circuit 700 shows a 3×3 array example (or 9 unit cells) but as noted previously, such circuits can be configured as an M×N array, where M and N are positive integers. A front side of the circuit 700 includes an antenna layer 710 having a front side 720 to passively collect MMW radiation and a back side 724 with waveguide channels to provide signal from the antenna layer. The dotted outline 728 represents the size of a receiver unit cell. Facing the backside of 710 is the front side of the MMIC/IC layer, with reference number 730 illustrating the front and back side of a unit cell of this layer. The front side component element of the MMIC/IC layer includes a front side 740 having an amplifier/detector portion 744 with a pick-up probe protruding into the opening that is aligned with a waveguide in the back side 724, and an LED driver section 748. Output from the front side 740 can be coupled through a via to the back side 750. The back side 750 also shows the waveguide opening for this unit cell. Output from the backside 750 can be coupled to an LED layer 760 having a front side 764 composed of waveguide back-shorts that align with the waveguide openings in the MMIC/IC layer, and a back side 768 containing the LEDS for generating an image. As noted previously, output from the LED layer 768 can be viewed directly by the human eye if the focal plane array were part of a pair of goggles or binoculars. In another example, output from the LED layer 768 can be imaged via a video capture device such as a film camera, digital camera, or electronic sensor such as a CMOS or CCD sensor, for example. As shown at 770, a side cutaway view of an assembled version of the circuit 700 provides a wavelength converter circuit as previously described configured as a 3×3 focal plane array.

What have been described above are examples. It is, of course, not possible to describe every conceivable combination of components or methodologies, but one of ordinary skill in the art will recognize that many further combinations and permutations are possible. Accordingly, the disclosure is intended to embrace all such alterations, modifications, and variations that fall within the scope of this application, including the appended claims. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

What is claimed is:

1. An imaging system comprising:
a receiver to passively receive a millimeter wave (MMW) power level input from a scene and generate an analog output signal;
a driver circuit to receive the analog output signal and generate a drive output signal based on the amplitude of the analog output signal; and
a wavelength converter that generates a light intensity output in response to the drive output signal, wherein the light intensity output is a replica of a portion of the scene associated with the MMW power level input at a different wavelength range than the MMW power level input wavelength range.

2. The imaging system of claim 1, further comprising a low noise amplifier to boost the passively received MMW power level input from the scene.

3. The imaging system of claim 2, further comprising a feed antenna to passively collect the MMW power level input from the scene and provide the MMW power level input from the scene to the low noise amplifier.

4. The imaging system of claim 3, wherein the feed antenna, the low noise amplifier, the driver circuit, and the wavelength converter are configured as an integrated circuit pixel.

5. The imaging system of claim 4, wherein the integrated circuit pixel is combined with at least one other integrated circuit pixel to form a focal plane array (FPA) assembly.

6. The imaging system of claim 1, further comprising an image capture device to capture the image of the scene from the light intensity output.

7. The imaging system of claim 6, wherein the light intensity output of the scene is coupled to the image capture device via a fiber optic connection.

8. The imaging system of claim 1, wherein the wavelength converter is a light emitting diode (LED).

9. The imaging system of claim 8, wherein the LED is configured to emit infrared spectrum frequencies, visible spectrum frequencies, or ultra violet spectrum frequencies.

10. The imaging system of claim 1, further comprising an optical front end to focus the MMW power level input from the scene onto the receiver.

11. An imaging system comprising:
an optical front end for passively capturing a millimeter wave (MMW) image of a scene;
an imaging assembly comprising:
a plurality of focal plane array receivers that each receives a PMMW power level input associated with the MMW image and each generates a respective analog output signal;
a plurality of driver circuits that each receives a respective analog output signal and generates a respective drive output signal based on the amplitude of the corresponding analog output signal; and
a plurality of wavelength converters that each generates a light intensity output in response to a respective drive output signal, wherein the light intensity output is a replica of a portion of the scene associated with the MMW power level input at a different wavelength range than the MMW power level input wavelength range.

12. The imaging system of claim 11, further comprising a plurality of feed antennas to passively collect the MMW power level input and provide the MMW power level input to the plurality of focal plane array receivers.

13. The imaging system of claim 12, further comprising an optical front end to focus the MMW power level input onto the plurality of feed antennas.

14. The imaging system of claim 13, further comprising an image capture device to capture the image of the scene from the light intensity output.

15. The imaging system of claim 14, wherein the light intensity output of the scene is coupled to the image capture device via a fiber optic connection.

16. The imaging system of claim 11, wherein the wavelength converter is a light emitting diode (LED).

17. The imaging system of claim 16, wherein the LED is configured to emit infrared spectrum frequencies, visible spectrum frequencies, or ultra violet spectrum frequencies.

18. An imaging system comprising:
an optical front end for passively capturing a millimeter wave (MMW) image of a scene;
a plurality of feed antennas that receives the MMW image of the scene from the optical front end and generates an antenna output signal;
a plurality of low noise amplifiers that boosts the antenna output signal to generate a MMW power level input associated with the MMW image;
a plurality of focal plane array receivers that each receives the MMW power level input associated with the MMW image and each generates a respective analog output signal;
a plurality of driver circuits that each receives a respective analog output signal and generates a respective drive output signal based on the amplitude of the corresponding analog output signal;
a plurality of wavelength converters that each generates a light intensity output in response to a respective drive output signal, wherein the light intensity output is a replica of a portion of the scene associated with the MMW power level input at a different wavelength range than the MMW power level input wavelength range; and
an image capture device that captures an image of the scene via the light intensity outputs.

19. The imaging system of claim 18, wherein the plurality of wavelength converters are a plurality of light emitting diodes.

20. The imaging system of claim 19, wherein the plurality of wavelength converters are configured for infrared light, visible light, or ultraviolet light.
